(19) United States
(12) Patent Application Publication
(10) Pub. No.: US 2009/0085997 A1
(43) Pub. Date: Apr. 2, 2009

(54) INKJET PRINTER

(75) Inventor: Kenichi SAKAMOTO, Wakayama (JP)

Correspondence Address: Studebaker & Brackett PC, 1890 Preston White Drive, Suite 105, Reston, VA, 20191, US

(73) Assignee: NORITSU KOKI CO., LTD., Wakayama (JP)

(21) Appl. No.: 12/206,236

(22) Filed: Sep. 8, 2008

(30) Foreign Application Priority Data
Sep. 27, 2007 (JP) 2007-251540

(51) Int. Cl. B41J 2/01

(52) U.S. Cl. 347/102

(57) ABSTRACT

In an inkjet printer configured so that dry air in a drying unit is blown out to a conveyance unit, the conveyance unit conveys one or more pieces of paper laid thereon in a direction substantially orthogonal to a direction of paper output and a collecting unit downstream of the conveyance unit in the direction of paper conveyance collects the pieces of paper and conveys the collected pieces of paper in a direction substantially orthogonal to the direction of paper conveyance of the conveyance unit.

### CROSS-REFERENCE TO RELATED APPLICATION

This application claims priority under 35 USC 119 to Japanese Patent Application No. 2007-251540 filed on Sep. 27, 2007, the entire contents of which are incorporated herein by reference.

### BACKGROUND OF THE INVENTION

(a) Field of the Invention

This invention relates to inkjet printers.

(b) Description of the Related Art

Inkjet printers are conventionally known as devices for printing characters and images (hereinafter, characters and images are generically called “images”). The inkjet printers print images on paper by reciprocal movement in the paper width direction of their print heads ejecting ink.

In such an inkjet printer, if printed pieces of paper are stacked one after another on the paper output tray with ink on the pieces of paper not yet dried up, this causes inconveniences, such as a phenomenon that the ink on each piece of paper cannot uniformly be dried to cause color shading of the printed images or a phenomenon that ink adheres to the back sides of the stacked pieces of paper. Therefore, it is necessary to stack the printed pieces of paper on the paper output tray after the ink is well dried.

Published Japanese Patent Application No. 2001-270089 discloses a technique for an inkjet printer including: an infrared heater for drying ink landed on printed paper by heat energy; and an air nozzle for spraying air to the surface of the paper increased in temperature by the infrared heater to reduce the temperature of the paper.

Other than the technique disclosed in Published Japanese Patent Application No. 2001-270089, there can be considered techniques in which a printer contains a dryer for drying a printed piece of paper by blowing dry air against it.

### SUMMARY OF THE INVENTION

When such a dryer is mounted in a printer, dry air flows through the output port in the printer body and is blown out to the paper output tray. Therefore, dry air resides on the paper output tray to form above the paper output tray a stuffy unpleasant ambience in which heat and moisture reside. The operator must pick up, in such an unpleasant ambience, printed pieces of paper laid on the paper output tray, which may deteriorate the paper pickup efficiency.

The present invention has been made in view of the foregoing points and, therefore, an object thereof is to provide an inkjet printer by which the operator has no need to pick up printed pieces of paper in an unpleasant ambience full of dry air for drying the pieces of paper and can pick up them comfortably.

To attain the above object, in the present invention, a placement device for laying printed pieces of paper thereon is configured to convey the pieces of paper in a direction substantially orthogonal to a direction of paper output, whereby the pieces of paper can be conveyed to a location kept away from the unpleasant ambience full of dry air and the operator can pick up the pieces of paper under a comfortable environment.

Specifically, the present invention is directed to an inkjet printer that includes: a printing device for printing an image on paper by ejecting ink to the paper; a drying device for drying the printed paper by blowing dry air against the printed paper; a paper output device, disposed downstream of the drying unit in a direction of paper conveyance, for outputting the paper; and a placement device for receiving the paper output from the paper output device, the dry air in the drying device being blown out to the placement device, and takes the following solutions.

In a first aspect of the invention, the placement device is configured to convey the paper laid thereon in a direction substantially orthogonal to the direction of paper output, and the inkjet printer further includes a collecting device, disposed downstream of the placement device in the direction of paper conveyance, for collecting the paper.

As described above, the paper laid on the placement device is conveyed by the placement device in the direction substantially orthogonal to the direction of paper output and collected by the collecting device located downstream in the direction of paper conveyance. Therefore, even if dry air in the drying device is blown out to the placement device so that a stuffy unpleasant ambience full of dry air is formed above the placement device, the space around the collecting device where the operator picks up the printed paper is kept away from the unpleasant ambience. This eliminates the need for the operator to pick up the paper in the unpleasant ambience and provides a comfortable paper pickup work, thereby increasing the paper pickup efficiency.

Alternatively, it may be considered so that the placement device is disposed to convey the paper substantially in parallel with the direction of paper output in order to keep the paper pickup space away from the unpleasant ambience. This is, however, undesirable because the total length of the inkjet printer is increased. In contrast, if the paper is conveyed in the direction substantially orthogonal to the direction of paper output as in the present invention, this is preferable because the inkjet printer can be downsized while the paper pickup space can be kept away from the unpleasant ambience.

A second aspect of the invention is the inkjet printer according to the first aspect of the invention, wherein the collecting device is configured to convey the collected paper in a direction substantially orthogonal to the direction of paper conveyance of the placement device.

Since the collecting device conveys the collected paper in the direction substantially orthogonal to the direction of paper conveyance of the placement device, the printed paper can be conveyed towards the paper feeding side of the inkjet printer and the operator can pick up the paper on the paper feeding side opposite to the unpleasant ambience existing on the paper output side of the inkjet printer and full of dry air, which increases the paper pickup efficiency. More specifically, in a common inkjet printer, an ink tank and a roll of paper web are disposed on the paper feeding side thereof. If the printed paper is conveyed to a region used for maintenance, such as replacement of ink or a roll of paper web, the operator can carry out the maintenance and paper pickup works at the same location as the location for paper feeding, without the need to move from the maintenance space to the paper pickup space in order to pick up the paper, and can carry out these necessary works at a location opposite to the unpleasant ambience. This provides a comfortable and efficient paper pickup work.

A third aspect of the invention is the inkjet printer according to the first aspect of the invention, wherein the collecting device includes a plurality of collecting plates and is configured so that the plurality of collecting plates divide a plurality of pieces of said paper conveyed from the placement device in units of print orders.

Since a plurality of pieces of paper are divided in units of print orders by the plurality of collecting plates provided in the collecting device, the operator does not need to manually assort the pieces of paper in units of print orders. Furthermore, if a given number of pieces of paper are printed and then picked up at a time, the number of paper pickup times can be reduced, which increases the paper pickup efficiency.

As described so far, according to the inkjet printer of the present invention, the paper laid on the placement device is conveyed by the placement device in the direction substantially orthogonal to the direction of paper output and collected by the collecting device located downstream in the direction of paper conveyance. Therefore, even if dry air in the drying device is blown out to the placement device so that a stuffy unpleasant ambience full of dry air is formed above the placement device, the working space around the collecting device where the operator picks up the printed paper is kept away from the unpleasant ambience. This eliminates the need for the operator to pick up the paper in the unpleasant ambience and provides a comfortable paper pickup work, thereby increasing the paper pickup efficiency.

### BRIEF DESCRIPTION OF THE DRAWINGS

FIG. 1 is a perspective view showing the appearance of an inkjet printer according to an embodiment of the present invention.

FIG. 2 is a plan view showing the appearance of the inkjet printer.

FIG. 3 is a front view showing the appearance of the inkjet printer.

FIG. 4 is a left side view showing the appearance of the inkjet printer.

FIG. 5 is a schematic diagram of the inkjet printer when viewed from the left of a housing, showing a conveyance path of printing paper.

FIG. 6 is a cross-sectional view showing the structure of a drying unit when viewed from the left of the housing.

FIG. 7 is a front view of the inkjet printer, showing a state that a conveyance unit is entirely turned so that a conveying belt vertically stands.

FIG. 8 is a plan view of the inkjet printer, showing a state that the conveyance unit is moved from the state shown in FIG. 7 towards a printer body.

FIG. 9 is a cross-sectional view showing the structure of a collecting unit, as viewed from the right side thereof.

FIG. 10 is a plan view showing the optical path of a optical sensor for determining whether any printed piece of paper is collected on a collecting plate.

### DETAILED DESCRIPTION OF THE INVENTION

A description is given below of an embodiment of the present invention with reference to the drawings. The following preferred embodiment is merely illustrative in nature and is not intended to limit the scope, applications and use of the invention.

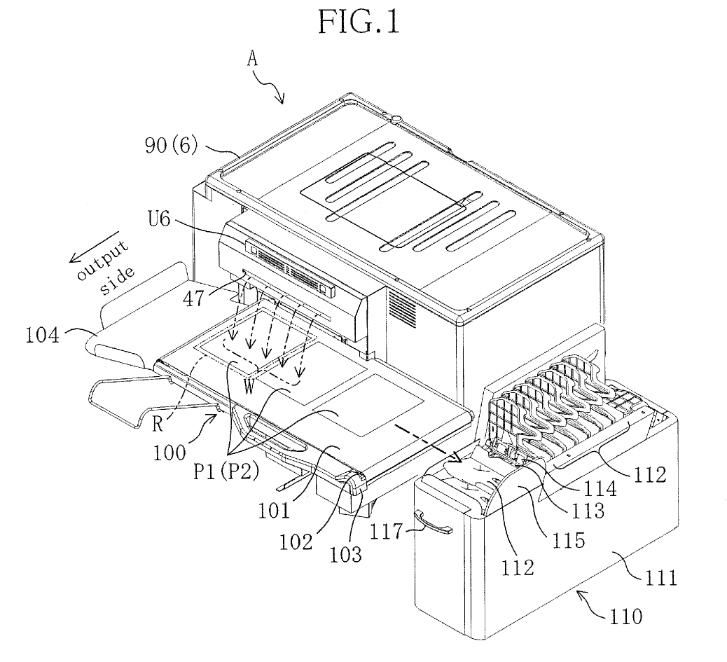

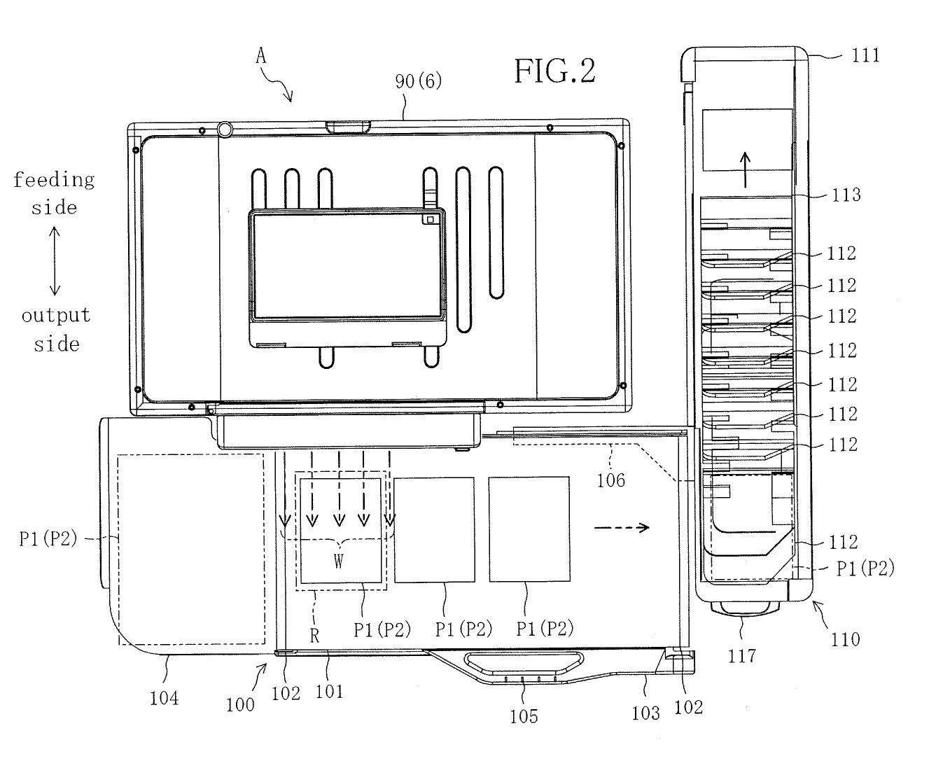

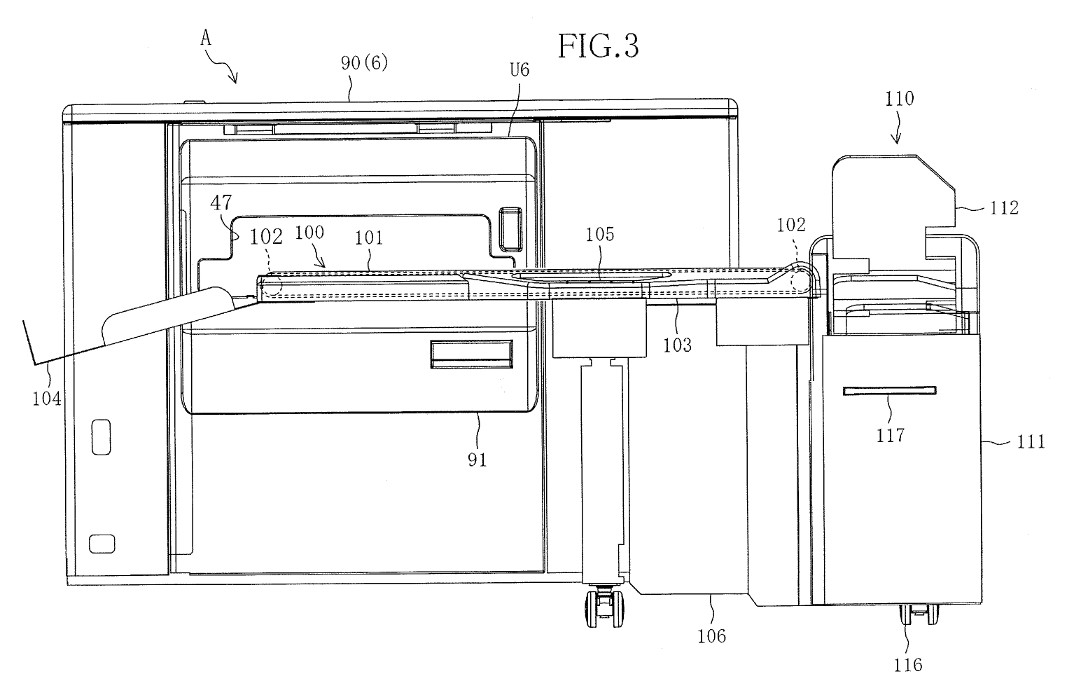

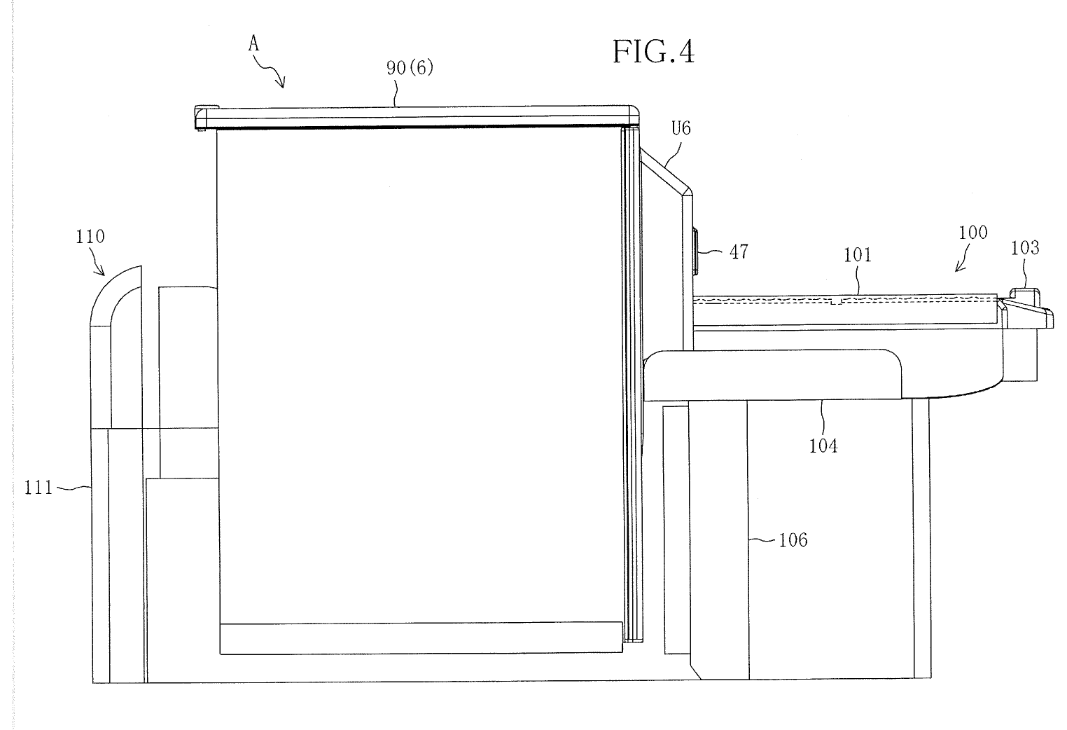

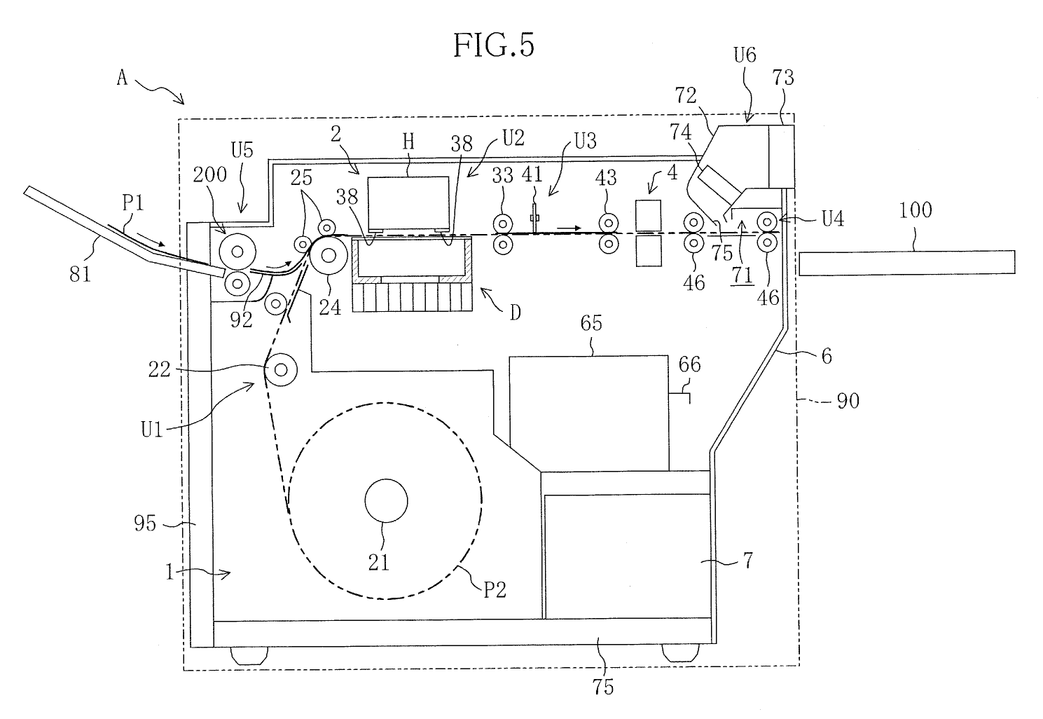

FIG. 1 is a perspective view showing the appearance of an inkjet printer A according to an embodiment of the present invention, FIG. 2 is a plan view of the inkjet printer A, FIG. 3 is a front view thereof, FIG. 4 is a left side view thereof and FIG. 5 is a schematic view thereof as viewed from the left of a housing, showing a conveyance path of printing paper. The inkjet printer A is used for a photographic printing system and, for example, used for printing photographic images on printing paper P1 or P2 based on image data transmitted via a communication cable from a reception block for obtaining the image data and correcting it as necessary. More specifically, the inkjet printer A is configured to be capable of performing an automatic printing for pulling out one end of a long roll of printing paper P2 and printing an image on the printing surface of the roll of printing paper P2 (hereinafter, referred to as a paper web P2) and a manual-feed printing for printing an image on the printing surface of a sheet of printing paper P1 (hereinafter, referred to as a paper sheet P1) previously cut in a given size.

Note that when in the following description the paper web P2 and the paper sheet P1 need not be particularly distinguished, they are referred to as printing paper P1 or P2. Furthermore, the printing surface means the surface on which an image is to be printed. The printing surface of each paper sheet P1 is determined when the paper sheet P1 is set on a manual-feed tray 81 (see FIG. 5). Specifically, the printing surface is the side of the paper sheet P1 facing upward when the paper sheet P1 is set on the manual-feed tray 81. On the other hand, the printing surface of the paper web P2 is the side thereof facing radially outward when the paper web P2 is rolled.

### —General Structure—

As shown in FIGS. 1 to 5, the inkjet printer A includes: a printer body 90; a conveyance unit 100 disposed downstream of the printer body 90 (on the under side thereof as viewed in FIG. 2); and a collecting unit 110 disposed downstream of the conveyance unit 100 in the direction of paper conveyance (on the right side thereof as viewed in FIG. 2).

The printer body 90 includes: a housing 6; a paper roll containing part 1 (containing room) disposed in a lower part of the interior of the housing 6 and containing a paper web P2 rolled with its printing surface outside; a printing part 2, disposed in an upper part of the interior of the housing 6 (above the paper roll containing part 1), for printing based on image data an image on the printing surface of the paper sheet P1 fed from a manual-feed tray 81 for manually setting the paper sheet P1 thereon or the printing surface of the paper web P2 pulled out of the paper roll containing part 1; ink storages (not shown), located in the lower part of the interior of the housing 6 on both sides of the paper roll containing part 1, for storing ink to be supplied to the printing part 2; and a roller unit 200, disposed on an upper part of a cover member 95 attached to the housing 6 to be freely opened and closed, for conveying and feeding a paper sheet P1 set on the manual-feed tray 81 towards the printing part 2 when the cover member 95 is closed.

Disposed in the upper part of the housing 6 and downstream of the printing part 2 in the direction of paper conveyance are a roller cutter 41 for cutting out an unnecessary part of printed printing paper P1 or P2, a back printing unit 4 for printing a serial number on the back side of each piece of printing paper P1 or P2, a drying unit U6 for drying the piece of printing paper P1 or P2 printed in the printing part 2, and a pair of upstream output rollers 45 vertically arranged and engaged against each other and a paper output unit U4 for conveying the piece of printing paper P1 or P2 printed in the printing part 2 further downstream and outputting it. Disposed downstream of the paper output unit U4 in the direction of paper conveyance is the conveyance unit 100 serving as a placement device for receiving the piece of printing paper P1 or P2 delivered by a pair of output rollers 46 in the paper output unit U4.

In this embodiment, the side of the housing 6 towards the conveyance unit 100 (“output side” shown in FIG. 2) is referred to as the housing front side, the side thereof opposite to the conveyance unit 100 (“feeding side” shown in FIG. 2) is referred to as the housing rear side, the left side thereof as viewed from the housing front side is referred to as the housing left side, and the right side thereof as viewed from the housing front side is referred to as the housing right side. Therefore, the right-to-left direction in FIG. 5 is the housing front-to-rear direction and the direction orthogonal to the drawing sheet of FIG. 5 is the housing right-to-left direction. The housing right-to-left direction coincides with the width direction of the paper sheet P1 set on and fed from the manual-feed tray 81 and the width direction of the paper web P2 contained in and fed from the paper roll containing part 1.

### —Paper Conveyance Mechanism—

As shown in FIG. 5, the inkjet printer A is provided with a paper conveyance mechanism for pulling a paper web P2 out of the paper roll containing part 1 and conveying it along a given conveyance path. To form the conveyance path, the paper conveyance mechanism includes, in order from a feed unit U1 for feeding the paper web P2, the feeding unit U1, a printing unit U2, a cutter unit U3, the drying unit U6 and the paper output unit U4. Thus, image data is printed on the printing surface of the printing paper P1 or P2 located on the conveyance path in the printing unit U2 provided in the printing part 2.

In this embodiment, for another paper feed path other than the feed path of the paper web P2 from the feeding unit U1 to the printing unit U2, the paper conveyance mechanism further includes a manual-feed unit U5 configured to pull in a paper sheet P1 from the manual-feed tray 81 and feed it to the printing part 2.

In printing on the paper web P2, the paper conveyance mechanism is configured so that the feeding unit U1 feeds the paper web P2 set in the paper roll containing part 1 to the printing unit U2, the printing unit U2 then prints image data on the fed paper web P2 with the print head H while conveying the paper web P2 towards the cutter unit U3, the cutter unit U3 then cuts the printed paper web P2 in a given print size, the drying unit U6 then dries the paper web P2 and the paper output unit U4 conveys the paper web P2 out to the conveyance unit 100. Hereinafter, upstream and downstream in the direction of conveyance of the paper web P2 being conveyed during printing are referred to simply as upstream and downstream, respectively.

The feed unit U1 includes a core roller 21 for winding a paper web P2 in a roll thereon to contain the rolled paper web P2 in the paper roll containing part 1, a transverse restriction roller 22 for restricting the transverse position of the paper web P2 pulled out of the core roller 21, a conveyance drive roller 24 capable of being driven into rotation by an unshown electric motor to convey the paper web P2, and two pinch rollers 25 opposed to the conveyance drive roller 24 and engageable against the conveyance drive roller 24 to pinch the paper web P2 together with the conveyance drive roller 24.

The feed unit U1 is configured to pull the paper web P2 out of the paper roll containing part 1 and also feed it to the printing part 2 by the rotation of the conveyance drive roller 24.

The printing unit U2 includes: the print head H for ejecting ink to the printing paper P1 or P2 to form an image on it; a paper holder D for holding by suction the printing paper P1 or P2 at a position allowing printing of the print head H; and a pair of paper conveyance rollers 33 disposed downstream of the paper holder D and engaged against each other. The conveyance drive roller 24 and the pinch rollers 25 in the feed unit U1 are used also as components of the printing unit U2 and act to convey the printing paper P1 or P2 in the printing unit U2.

The cutter unit U3 includes a roller cutter 41 and is configured to cut the printing paper P1 or P2 into a given size (length) by moving the roller cutter 41 in the width direction at an appropriate position of the length of the printing paper P1 or P2 while rotating the roller cutter 41. Disposed below the roller cutter 41 is a chip collecting box 65 for collecting chips of the printing paper P1 or P2 formed by the cutting. The chip collecting box 65 is configured so that the operator can slide it out of the housing 6 by pulling its handle 66 and take out the chips collected in it. Disposed below the chip collecting box 65 is a waste tank 7 configured so that ink recovered by the printing unit U2 is guided into it.

The piece of printing paper P1 or P2 cut by the cutter unit U3 is conveyed to the paper output unit U4 by means of a pair of conveyance rollers 43 vertically arranged and engaged against each other. The back printing unit 4 is disposed between the cutter unit U3 and the paper output unit U4. In the back printing unit 4, a serial number or the like is printed on the back (underside) of each piece of printing paper P1 or P2 passing through it.

The paper output unit U4 includes two pairs of output rollers 46 and 46 for conveying the piece of printing paper P1 or P2 and outputting it to the conveyance unit 100. Disposed between these two pairs of output rollers 46, 46 is the drying unit U6 for drying the piece of printing paper P1 or P2 by blowing dry air W against the piece of printing paper P1 or P2. The drying unit U6 sucks air into the housing 6 through an air inlet 48 formed in the housing 6 above and in the vicinity of the output port 47, applies heat to the sucked air and blows out the air as dry air W. The air inlet 48 is provided with a dust collection filter 49 to prevent dusts in the air from being sucked into the drying unit U6.

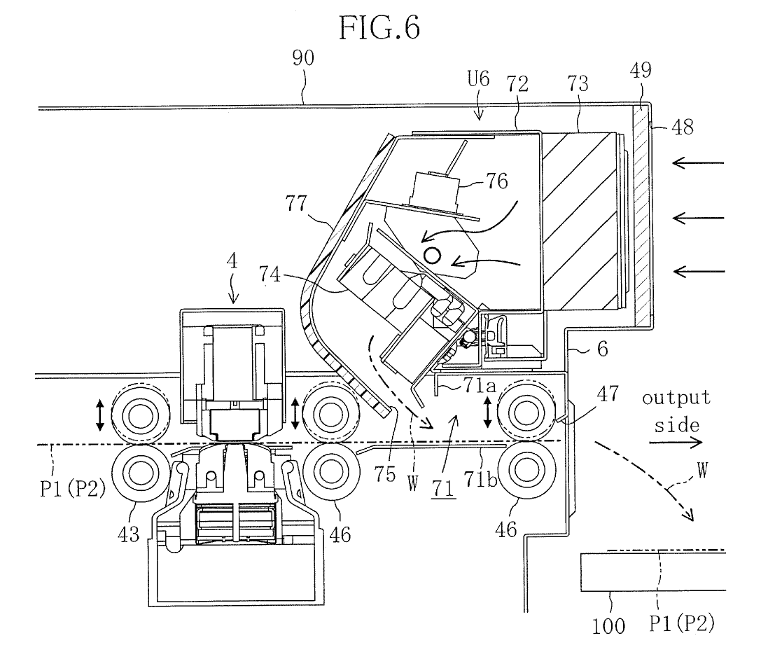

The drying unit U6 includes, as shown in FIG. 6, a drying chamber 71 disposed on the conveyance path of the printing paper P1 or P2 and a dryer 72 (drying device) for supplying dry air W to the drying chamber 71. The drying chamber 71 is defined by an upper partition wall 71a and a lower partition wall 71b that are opposed to each other with the piece of printing paper P1 or P2 therebetween, and constitutes a retention space for retaining dry air W blown against the piece of printing paper P1 or P2 from the dryer 72.

The dryer 72 includes a plurality of intake fans 73 disposed in the housing 6 at laterally spaced intervals to take air from the outside through the air inlet 48 in the housing 6 into the dryer 72, a heater 74 for heating the air taken in by the intake fans 73, an exhaust nozzle 75, disposed at the lower end of the dryer 72 and opening downstream in the direction of paper conveyance, for blowing dry air W heated by the heater 74 therethrough downstream in the direction of paper conveyance, and a safety thermostat 76 for detecting the internal temperature of the dryer 72 and stopping the heater 74 in time of necessity. A heat insulating material 77 is attached to an upstream portion of the body outer wall of the dryer 72 in the direction of paper conveyance, also including the exhaust nozzle 75. The provision of such a heat insulating material 77 restrains heat radiated by the dryer 72 from being transmitted to the units disposed upstream of the dryer 72 in the direction of paper conveyance and weak against heat, such as the back printing unit 4 using an ink ribbon.

The drying unit U6 is configured to blow dry air W against the printed piece of printing paper P1 or P2 and downstream in the direction of paper conveyance and then let the dry air W through the output port 47 in the housing 6 out of the housing 6. The dry air W let out of the housing 6 is blown against another piece of printing paper P1 or P2 laid on the conveyance unit 100.

Since such a drying unit U6 is provided, the drying of ink ejected from the print head H to the piece of printing paper P1 or P2 can be promoted by the blowing of dry air W even if the ink on the printed piece of paper is not yet dried. Furthermore, since the dry air W blown against a piece of printing paper P1 or P2 is let through the output port 47 in the housing 6 out of the housing 6 to be blown against another piece of printing paper P1 or P2 laid on the conveyance unit 100, the piece of printing paper P1 or P2 having had not been fully dried in the drying chamber 71 can be dried also on the conveyance unit 100, which provides efficient drying of each piece of printing paper P1 or P2. Furthermore, since the dry air W is blown through the output port 47 out of the housing 6, this prevents heat from continuing to reside in the housing 6 and thereby prevents heat produced in the drying unit U6 from being transmitted to the upstream units, such as the back printing unit 4, which is preferable for the inkjet printer A.

Meanwhile, when dry air W is blown through the output port 47 out of the housing 6, it resides around the output port 47 to form near the output port 47 in the room space a stuffy unpleasant ambience in which heat and moisture reside. If the inkjet printer A, as in the known inkjet printers, had a configuration in which the printed piece of printing paper P1 or P2 output through the output port 47 was laid on a paper output tray, the operator would have to pick up the printed piece of printing paper P1 or P2 from the paper output tray in a stuffy unpleasant ambience in which dry air W resided, which might deteriorate the paper pickup efficiency. In contrast to the above, in the present invention, the piece of printing paper P1 or P2 output through the output port 47 is conveyed to a location kept away from the unpleasant ambience in which dry air W resides, whereby the piece of printing paper P1 or P2 can be picked up under a comfortable environment.

### —Conveyance Unit—

A description is given below of the structures of the conveyance unit 100 and the collecting unit 110, which are features of the present invention. The conveyance unit 100 constitutes a placement device for receiving a piece of printing paper P1 or P2 output through the output port 47 in the housing 6 of the printer body 90 and includes: a conveying belt 101 for conveying the piece of printing paper P1 or P2 in a manner like a belt conveyer; a plurality of drive rollers 102 for driving the conveying belt 101; a conveyance unit body 103 supporting the drive rollers 102 to allow the rotation of the drive rollers 102; and a large-sized paper tray 104 disposed upstream of the conveying belt 101 in the direction of paper conveyance and attached to the conveyance unit body 103.

A portion of the conveying belt 101 adjoining the output port 47 in the housing 6 is a paper placement region R where a piece of printing paper P1 or P2 just after output through the output port 47 is received. Furthermore, the conveyance unit 100 is configured to control the conveying belt 101 so that before the next piece of printing paper P1 or P2 output through the output port 47 in the housing 6 is laid on the paper placement region R, the conveying belt 101 evacuates the current piece of printing paper P1 or P2 being laid on the paper placement region R from it.

This prevents pieces of printing paper P1 or P2 from being overlapped one with another on the conveying belt 101 and thereby prevents inconveniences, such as color shading, due to uneven drying of ink on each piece of printing paper P1 or P2.

Instead of continuing to drive the conveying belt 101 at a constant speed, pieces of printing paper P1 or P2 may be intermittently conveyed by conveying the current piece of printing paper P1 or P2 being laid on the paper placement region R to the outside of the paper placement region R at a stroke in outputting the next piece of printing paper P1 or P2.

Furthermore, the conveyance unit 100 is configured to control the conveying belt 101 so that when a piece of printing paper P1 or P2 of photographic print size, such as an L-sized print, is laid on the conveying belt 101, the conveying belt 101 conveys it to the collecting unit 110 disposed downstream in the direction of paper conveyance (to the right in FIG. 2) and that when a larger-sized piece of printing paper P1 or P2, such as a B5 or A4 print, is laid on the conveying belt 101, the conveying belt 101 conveys it to the large-sized paper tray 104 upstream in the direction of paper conveyance. Since in the above manner the direction of conveyance of piece of printing paper P1 or P2 is changed according to the size thereof, each piece of printing paper P1 or P2 can be conveyed to an appropriate collecting point for each paper size.

The conveyance unit 100 includes a handle 105 disposed on the front side of the conveyance unit body 103 (on the under side thereof as viewed in FIG. 2). The conveyance unit 100 is configured so that when the operator grasps the handle 105 and pulls it frontward, the entire conveyance unit 100 moves frontward and the conveyance unit body 103 is thereby disengaged from an unshown positioning engagement pin extending from the printer body 90 towards the conveyance unit 100.

Furthermore, as shown in FIG. 2, the conveyance unit body 103 of the conveyance unit 100 is placed on the top of a support corner wall 106 extending from a side wall of a later-described collecting unit body 111 of the collecting unit 110 towards the conveyance unit 100. When the conveyance unit body 103 is moved frontward, it becomes unoverlapped with the support corner wall 106 as viewed in plan view and is released from the support of the support corner wall 106.

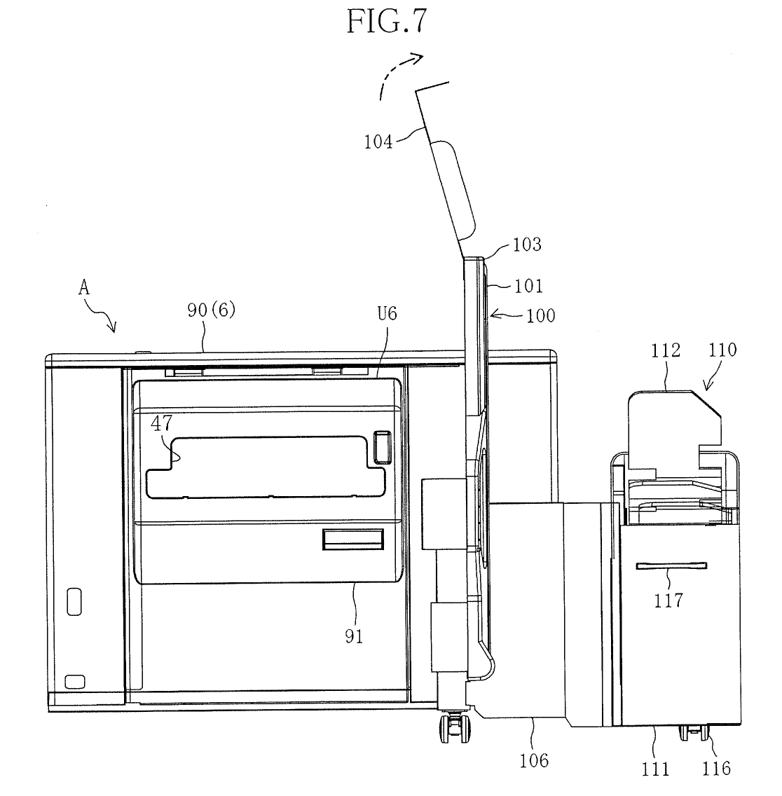

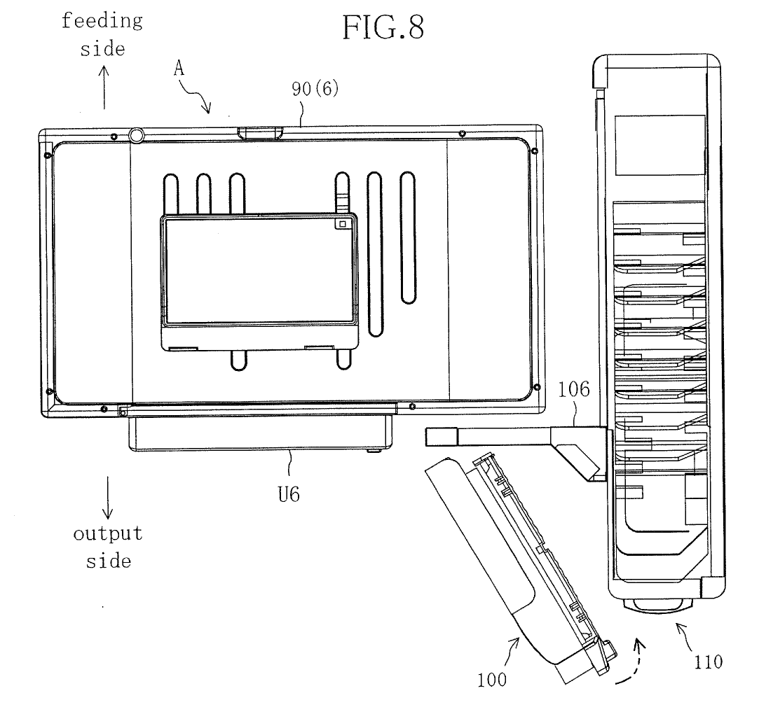

Furthermore, the conveyance unit body 103 is configured to pivotally move about an unshown pivot shaft extending frontward from the support corner wall 106. Thus, the conveyance unit body 103 can be pivotally moved clockwise in FIG. 7 so that the conveying belt 101 can vertically stand. Furthermore, the conveyance unit body 103 is configured to be capable of pivotally moving counterclockwise in FIG. 8 by means of an unshown hinge attached to the support corner wall 106. With this configuration, a cover 91, provided in the front of the printer body 90 but overlapped with and hidden behind the conveyance unit 100 as viewed from the front of the inkjet printer A in operation, can be opened and closed. By opening the cover 91, the chip collecting box 65 collecting chips formed by the cutter unit U3 and the waste tank 7 containing ink recovered by the printing unit U2 can be pulled out of the printer body 90 to take out the chips and wasted ink.

### —Collecting Unit—

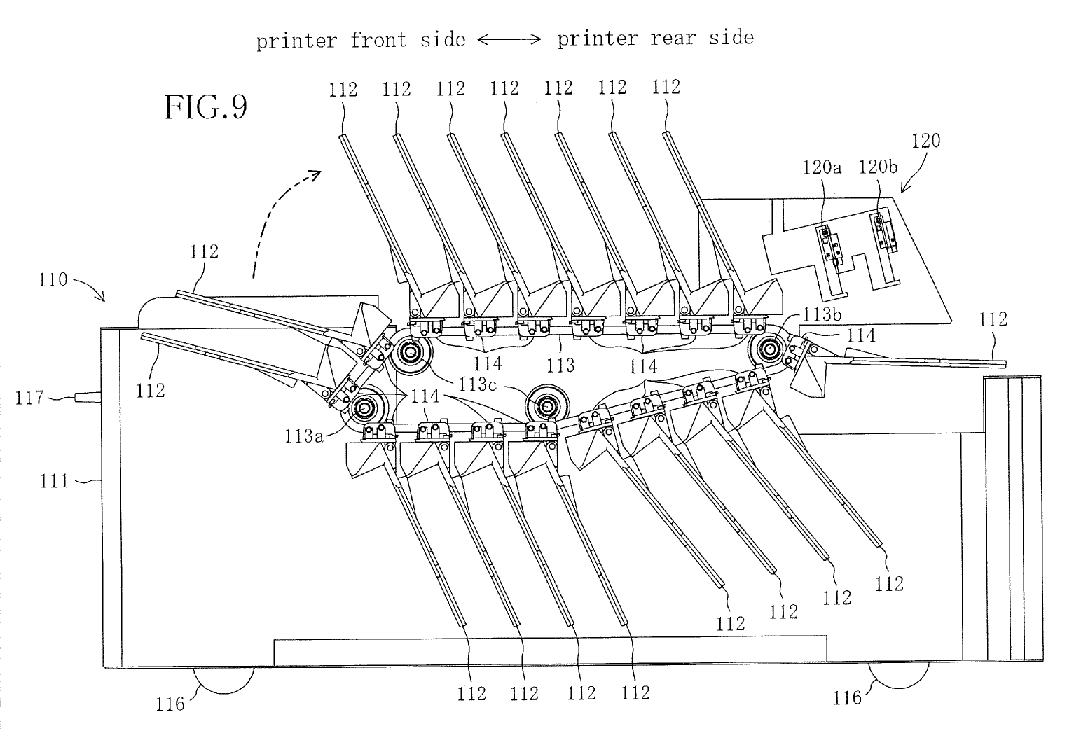

The collecting unit 110 is disposed downstream of the conveyance unit 100 in the direction of paper conveyance (to the right thereof in FIG. 2) for the purpose of collecting pieces of printing paper P1 or P2 conveyed from the conveyance unit 100. The collecting unit 110 includes: a box-shaped collecting unit body 111 opening at the top; an upstream conveyance roller 113a disposed in the collecting unit body 111 towards the upstream side of the collecting unit body 111 (the left side thereof in FIG. 9); a downstream conveyance roller 113b disposed in the collecting unit body 111 towards the downstream side of the collecting unit body 111 (the right side thereof in FIG. 9); two intermediate rollers 113c, 113c disposed between the upstream conveyance roller 113a and the downstream conveyance roller 113b; an endless collecting belt 113 wrapped around the rollers 113a to 113c with an appropriate tension applied thereto; a plurality of holders 114 disposed on the outer periphery of the collecting belt 113 at substantially equal intervals; and a plurality of collecting plates 112 detachably held by the holders 114, one collecting plate 112 for each holder 114.

At least one of the upstream and downstream conveyance rollers 113a and 113b is connected to an unshown driving device for rotating the collecting belt 113 to move the collecting plates 112 in the direction of paper conveyance.

A pair of casters 116 are attached to the bottom of the collecting unit body 111. Thus, the operator can move the collecting unit body 111 to a transfer point for the printing paper P1 or P2 downstream of the conveyance unit 100 while grasping a handle 117 attached to the front of the collecting unit body 111, whereby the collecting unit 110 can be accurately positioned at the transfer point for the printing paper P1 or P2.

The collecting belt 113 is disposed in an upper part of the internal space of the collecting unit body 111 to prevent the distal ends of the collecting plates 112 located on the under side of the collecting belt 113 from coming into contact with the bottom surface of the collecting unit body 111.

The collecting plates 112 are attached through their respective holders 114 to the collecting belt 113 and configured to follow the rotation of the collecting belt 113 so that those located on the top side of the collecting belt 113 move towards the rear of the housing 6 (to the right in FIG. 9) and those located on the under side of the collecting belt 113 move towards the front of the housing 6 (to the left in FIG. 9). In short, the collecting plates 112 are configured to be capable of continuously moving orbitally around the rollers 113a to 113c together with the traveling of the collecting belt 113. Furthermore, each collecting plate 112 is detachably held by the associated holder 114 and configured to leave from the holder 114 when a load over a certain limit is applied thereto.

Furthermore, each collecting plate 112 can be put on standby at the transfer point for the printing paper P1 or P2 downstream of the conveying belt 101, with its surface in a horizontal position and substantially flush with the surface of the conveying belt 101. When the number of pieces of printing paper P1 or P2 ordered by a print order are collected on the collecting plate 112 at the transfer point, the collecting plate 12 is conveyed downstream by the collecting belt 113 before a piece of printing paper P1 or P2 for the next print order is conveyed to the transfer point. Then, the collecting plate 112 whose surface has been kept horizontal stands up in the course of travel of the collecting belt 113. Thus, the plurality of collecting plates 112 function as divider plates dividing a plurality of pieces of printing paper P1 or P2 in units of print orders.

In the collecting unit 110 in this embodiment, one or more pieces of printing paper P1 or P2 are first collected on the collecting plate 112 located at a collection standby point (a point where the collecting plate 112 is on standby in a horizontal position in order to collect the one or more pieces of printing paper P1 or P2). For example, one or more pieces of printing paper P1 or P2 for one order are collected on the collecting plate 112.

Next, the collecting belt 113 is driven to move the collecting plate 112 downstream by one interval (i.e., the interval between each two adjacent collecting plates 112). More specifically, the collecting plate 112 on which one or more pieces of printing paper P1 or P2 for one order are collected moves downstream to the top side of the collecting belt 113, whereby the next collecting plate 112 is located at the collection standby point.

A description is now given of a specific structure for implementing the positioning of one of the collecting plates 112 at the collection standby point for each order. Each holder 114 has a detection piece (not shown) extending substantially from the transverse middle of the bottom thereof. Furthermore, the collecting unit body 111 has a transmissive detection sensor (not shown) provided substantially in the longitudinal middle thereof to detect the detection piece. The collecting belt 113 is controlled to continue to convey the collecting plates 112 when the detection sensor does not detect any detection piece of any holder 114 but to stop the conveyance when the detection sensor detects one of the detection pieces. In other words, when one of the collecting plates 112 is positioned at the collection standby point, the holder 114 located substantially in the longitudinal middle of the collecting unit body 111 is detected by the detection sensor and the collecting belt 113 thereby stops its conveyance of the collecting plates 112. Then, when one or more piece of printing paper P1 or P2 for one order are collected on the collecting plate 112, a conveyance start signal is output from an unshown controller to start the travel of the collecting belt 113. Thereafter, when the detection sensor detects the detection piece of the next holder 114 moved one interval downstream, the travel of the collecting belt 113 is stopped again and another of the collecting plates 112 is positioned at the collection standby point.

In this embodiment, such collection and conveyance for each order are repeated, so that one or more pieces of printing paper P1 or P2 for individual orders can be conveyed as they are collected between each two adjacent collecting plates 112. Furthermore, the collecting unit 110 is configured so that before each collecting plate 112 moves to the under side of the collecting belt 113, the operator can pick up the pieces of printing paper P1 or P2 collected on the collecting plate 112.

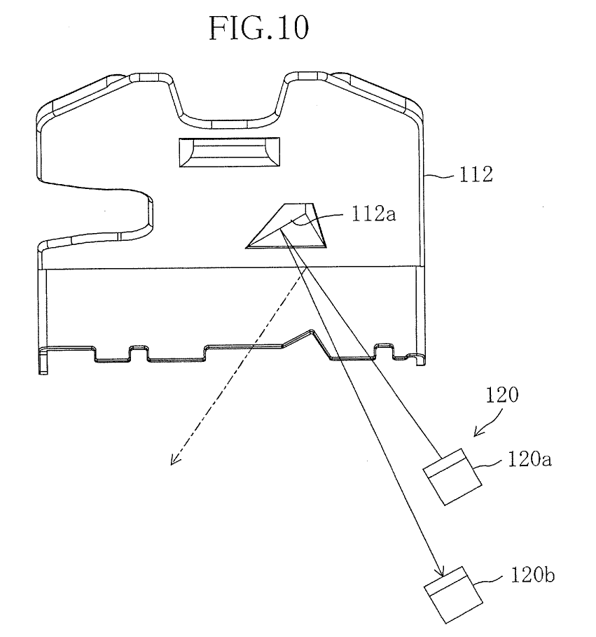

Specifically, disposed to the downstream side of the collecting unit body 111 is an optical sensor 120 including a light emitting element 120a and a light receiving element 120b. The optical sensor 120 is configured to be capable of determining whether one or more pieces of printing paper P1 or P2 are collected on the collecting plate 112 just before being moved to the under side of the collecting belt 113. As shown in FIG. 10, a recess having a reflective surface 112a is formed in the surface of each collecting plate 112. Light emitted from the light emitting element 120a of the optical sensor 120 is reflected by the reflective surface 112a and then received by the light receiving element 120b.

When no piece of printing paper P1 or P2 is collected on the collecting plate 112, light emitted from the light emitting element 120a to the collecting plate 112 is reflected by the reflective surface 112a and received by the light receiving element 120b (see the optical path indicated in the solid lines in FIG. 10). On the other hand, when one or more pieces of printing paper P1 or P2 are collected on the collecting plate 112, light emitted from the light emitting element 120a is reflected by the pieces of printing paper P1 or P2 before reaching the reflective surface 112a and thereby changes its angle of reflection, whereby the reflected light is not received by the light receiving element 120b (see the optical path indicated in the dash-double-dot line in FIG. 10). When the reflected light cannot be received by the light receiving element 120b in this manner, it is determined that one or more pieces of printing paper P1 or P2 are collected on the collecting plate 112 located at the most downstream point, and the travel of the collecting belt 113 is stopped. Thus, the operator can pick up the pieces of printing paper P1 or P2 from the collecting plate 112 at the most downstream point. Then, the collecting plate 112 after the completion of collection and conveyance moves to the under side of the collecting belt 113 with the rotation of the collecting belt 113.

The collecting unit body 111 further includes a guide plate 115 vertically standing on the top of a side wall thereof at the transfer point for the printing paper P1 or P2 (a right side wall thereof as viewed in FIG. 2). The guide plate 115 is used for guiding pieces of printing paper P1 or P2 transferred one after another from the conveyance unit 100 to the collecting unit 110 to stack them on the associated collecting plate 112 with their right edges aligned with each other, and has a configuration in which it inclines diagonally upward right (for example, at about three degrees). Since the guide plate 115 has the above configuration, this prevents such an inconvenience that while the surface of the collecting plate 112 having been kept horizontal stands up in the course of travel of the collecting belt 113, the right edges of pieces of printing paper P1 or P2 rub against the guide plate 115 and thereby scratch it. Thus, deterioration of print quality can be prevented.

The conveyance unit 100 controls the driving of the conveying belt 101 so that upon transfer of a piece of printing paper P1 or P2 from the conveying belt 101 to the associated collecting plate 112 of the collecting unit 110, the conveying belt 101 can convey the piece of printing paper P1 or P2 at a predetermined conveyance speed or higher. Specifically, a gap is formed between the conveying belt 101 and the collecting plate 112 at the collection standby point. Therefore, if the conveyance speed of the conveying belt 101 were too low, the leading edge of the piece of printing paper P1 or P2 might fall into the gap to prevent a smooth paper transfer or bring the paper transfer itself into failure. To cope with this, in this embodiment, the conveyance speed of the conveying belt 101 is controlled at a speed at which a piece of printing paper P1 or P2 can be stably transferred or a higher speed, thereby ensuring the transfer of the piece of printing paper P1 or P2. Even when the transfer speed of a piece of printing paper P1 or P2 is increased, the piece of printing paper P1 or P2 can be stably transferred because the guide plate 15 prevents it from jumping out of the collecting unit 110.

As described so far, according to the inkjet printer A of this embodiment of the present invention, pieces of printing paper P1 or P2 laid on the conveying belt 101 are conveyed by the conveyance unit 100 in the direction substantially orthogonal to the direction of paper output and collected by the collecting unit 110 downstream in the direction of paper conveyance. Therefore, even if dry air W in the drying unit U6 is blown out to the conveyance unit 100 so that a stuffy unpleasant ambience full of dry air W is formed above the conveyance unit 100, the working space around the collecting unit 110 where the operator picks up printed pieces of printing paper P1 or P2 is kept away from the unpleasant ambience. This eliminates the need for the operator to pick up pieces of printing paper P1 or P2 in the unpleasant ambience and provides a comfortable paper pickup work, thereby increasing the paper pickup efficiency.

As seen from the above description, the present invention has the following highly practical effect: to provide an inkjet printer by which the operator has no need to pick up printed pieces of paper in an unpleasant ambience full of dry air for drying the pieces of paper and can pick up them comfortably. Therefore, the present invention is very useful and has high industrial applicability.

What is claimed is:

1. An inkjet printer comprising:
a printing device for printing an image on paper by ejecting ink to the paper;
a drying device for drying the printed paper by blowing dry air against the printed paper;
a paper output device, disposed downstream of the drying unit in a direction of paper conveyance, for outputting the paper; and
a placement device for receiving the paper output from the paper output device, the dry air in the drying device being blown out to the placement device, wherein
the placement device is configured to convey the paper laid thereon in a direction substantially orthogonal to the direction of paper output, and
the inkjet printer further comprises a collecting device, disposed downstream of the placement device in the direction of paper conveyance, for collecting the paper.

2. The inkjet printer of claim 1, wherein the collecting device is configured to convey the collected paper in a direction substantially orthogonal to the direction of paper conveyance of the placement device.

3. The inkjet printer of claim 1, wherein the collecting device comprises a plurality of collecting plates and is configured so that the plurality of collecting plates divide a plurality of pieces of said paper conveyed from the placement device in units of print orders.
